(19) United States
(12) Patent Application Publication
(10) Pub. No.: US 2016/0285501 A1
(43) Pub. Date: Sep. 29, 2016

(54) MULTI-BAND COMMUNICATIONS MODULE AND HIGH FREQUENCY SWITCH

(71) Applicant: SAMSUNG ELECTRO-MECHANICS CO., LTD., Suwon-si (KR)

(72) Inventors: Jae Yong JEONG, Suwon-si (KR); Seong Yeon KIM, Suwon-si (KR)

(73) Assignee: SAMSUNG ELECTRO-MECHANICS CO., LTD., Suwon-si (KR)

(21) Appl. No.: 15/072,897

(22) Filed: Mar. 17, 2016

(30) Foreign Application Priority Data
Mar. 25, 2015 (KR) 10-2015-0041618

(51) Int. Cl. H04B 1/44; H04B 1/00

(52) U.S. Cl. CPC H04B 1/44; H04B 1/0057

(57) ABSTRACT

A multi-band communications module includes a circuit configured to process RF signals having different bands, switches respectively connected between the circuit and at least one of antennas, each switch respectively passing or blocking one of the RF signals; and a connector electrically connecting two switching units transferring or blocking RF signals having different bands, among the switches. Such a module has improved isolation characteristics without substantially reducing the operability and functionality of the multi-band communications module.

### CROSS-REFERENCE TO RELATED APPLICATION(S)

This application claims the benefit under 35 USC 119(a) of Korean Patent Application No. 10-2015-0041618 filed on Mar. 25, 2015 in the Korean Intellectual Property Office, the entire disclosure of which is incorporated herein by reference for all purposes.

### BACKGROUND

1. Field

The following relates to a multi-band communications module and a corresponding high frequency switch.

2. Description of Related Art

With the development of various types of wireless communications technology, a single device may be used to undertake communications conforming to various communications standards. For example, a multi-band scheme, in which communications within both the 2 GHz band and the 5 GHz band are supported by a single device, has been used.

Furthermore, a location-based service using a multi-band communications module has been provided. For example, angle of arrival (AOA) technology using Bluetooth™ has also rapidly become popular.

In the design of multi-band communications modules supporting typical angle of arrival (AOA) functions, isolation characteristics of a high frequency switch may deteriorate and thus coupling may occur. Because of the deterioration of isolation, signals may degrade. For example, a Bluetooth™ transmission RF signal may affect WIFI reception performance in such an example. As a result, the multi-band communications module struggles to satisfy various requirements of communications standards and the functionality of a low noise amplifier (LNA) may be jeopardized.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present examples provides a multi-band communications module and a corresponding high frequency switch.

In one general aspect, a multi-band communications module includes a circuit configured to process RF signals having different bands, switches respectively connected between the circuit and at least one of antennas, each switch respectively passing or blocking one of the RF signals, and a connector electrically connecting two switches transferring or blocking RF signals having different bands, among the switches.

The circuit may perform an angle of arrival operation and may receive and process an RF signal for an angle of arrival operation transferred through the connector.

At least one of the switches may process RF signals required for the angle of arrival operation using a lump processing approach.

At least one of the switches may consider isolation characteristics during passing or blocking an RF signal.

The circuit may processes an RF signal within a 2 GHz band and an RF signal within a 5 GHz band and the connector may electrically connects a switch that transfers or blocks the RF signal within the 2 GHz band and a switch that transfers or blocks the RF signal within the 5 GHz band.

The connector may include a matcher configured to match at least two of the switches on the basis of the switches being within the 2 GHz band or the 5 GHz band.

The matcher may be implemented using an open stub matching structure.

The switching units may include a low noise amplifier (LNA) configured to amplify an RF signal received from an antenna, and the connector may be connected to an output terminal of the low noise amplifier.

The multi-band communications module may further include a diplexer, connected to the switches, configured to transfer one of RF signals having bands and to block the remaining RF signals.

In response to a transmission RF signal being output from the circuit, the switches may pass the transmission RF signal and may cut off a receiving RF signal.

A difference in frequencies of the RF signals that the switches pass or block may be larger than a preset value.

The preset value may be about 3 GHz.

In another general aspect, a high frequency switch includes a first switch connected between a first transmitting port for transmitting a first RF signal within a first band and a first receiving port for receiving the first RF signal and a first antenna port and a second antenna port, configured to transfer or block the first RF signal, a second switch connected between a second transmitting port for transmitting a second RF signal within a second band and a second receiving port for receiving the second RF signal and the first antenna port and the second port, configured to transfer or block the second RF signal, and a third switch connected between a third transmitting and receiving port for transmitting and receiving a third RF signal within the first band and a third antenna port, configured to transfer or block the third RF signal, wherein a node between the third switch and the third antenna port is electrically connected to a node between the second switch and the second receiving port.

The third switch may receive an RF signal for an angle of arrival operation from the second switch and the third antenna port and transfers the received RF signal through the third transmitting and receiving port.

The first switch may further include a first low noise amplifier configured to amplify the first RF signal received from the first antenna port or the second antenna port and to output the amplified first RF signal into the first receiving port, and the second switch may further include a second low noise amplifier configured to amplify the second RF signal received from the first antenna port or the second antenna port and to output the amplified second RF signal into the second receiving port.

The high frequency switch may further include a matcher configured to match the second switch and the third switch in response to being within the first band, and a diplexer connected between the first switch and the second switch and the first antenna port and the second antenna port, configured to transfer one of RF signals having bands and to block the remainder thereof.

Other features and aspects will be apparent from the following detailed description, the drawings, and the claims.

### BRIEF DESCRIPTION OF THE DRAWINGS

FIG. 1 is a diagram illustrating a multi-band communications module according to an example.

FIG. 2 is a diagram illustrating the multi-band communications module according to the example of FIG. 1 in further detail.

FIG. 3 is a diagram illustrating a high frequency switch according to an example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Hereinafter, examples are described in further detail with reference to the accompanying drawings.

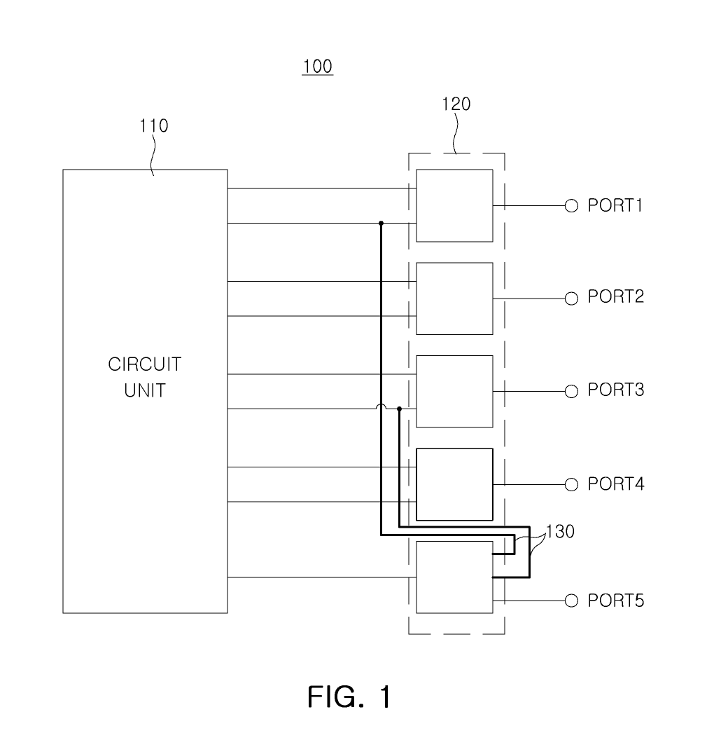

FIG. 1 is a diagram illustrating a multi-band communications module according to an example.

Referring to the example of FIG. 1, the multi-band communications module 100 includes a circuit unit 110, a plurality of switching units 120, and at least one connection unit 130.

In an example, the circuit unit 110 processes RF signals including a plurality of bands. For example, the circuit unit 110 processes a WIFI RF signal within the 2 GHz band, based on an 802.11a/b/g/n protocol, process a WIFI RF signal within the 5 GHz band based on an 802.11ac protocol, and process a Bluetooth™ RF signal within the 2 GHz band.

To process the RF signals in this manner, the circuit unit 110 performs a series of operations of processing a digital RF signal, converting the digital RF signal into an analog RF signal, and processing the analog RF signal to output a transmission RF signal. Further, the circuit unit 110 performs similar steps in reverse to process a received RF signal.

For example, the plurality of switching units 120 are connected to the circuit unit 110 to transfer or block each of the plurality of RF signals. That is, when the transmission RF signal is output from the circuit unit 110, the plurality of switching units 120 pass the transmission RF signal and also cut off the receiving RF signal.

For example, the plurality of switching units 120 operate as a front-end module for transmitting a high frequency RF signal to an antenna or receiving the high frequency RF signal from the antenna.

At least one connection unit 130 electrically connects two switching units that transfer or block RF signals having different bands to each other, among the plurality of switching units 120. For example, each of the connection units may electrically connect a switching unit connected to a first port PORT1 and a switching unit connected to a fifth port PORT5 to each other and electrically connect a switching unit connected to a third port PORT3 and a switching unit connected to the fifth port PORT5 to each other. However, this is merely an example, and there may be differing numbers of connection units 130 and they may connect different switching units chosen from the plurality of switching units 120.

Thus, the two switching units are electrically connected to each other by the at least one connection unit 130, such that at least one of the plurality of switching units 120 is able to process RF signals required for an angle of arrival (AOA) operation using a lump processing approach.

In this example, the switching unit connected to the at least one connection unit 130 considers isolation characteristics so as to operate properly. For example, when the switching unit connected to the fifth port PORT5 processes the transmission RF signal and when the switching unit connected to the first port PORT1 or the switching unit connected to the third port PORT3 processes the receiving RF signal, a proper amplitude of a coupling RF signal is determined based on the isolation characteristics, by using the shared information.

In further detail, the transmission RF signal within the switching unit connected to the fifth port PORT5 is primarily coupled to at least one connection unit 130. However, the primarily coupled RF signal is also secondarily coupled to the switching unit connected to the first port PORT1 and the switching unit connected to the third port PORT3. Thus, the switching unit connected to the first port PORT1 and the switching unit connected to the third port PORT3 is potentially damaged and accordingly cannot satisfy the isolation characteristics.

However, in the multi-band communications module 100 according to the examples, a difference in frequencies of the RF signals that pass through or cut off each of the switching units electrically connected to each other among the plurality of switching units 120 is larger than a preset value. In an example, the preset value is about 3 GHz.

In connection with this approach, the multi-band communications module 100 is described under the assumption that the WIFI RF signal within the 5 GHz band is transmitted and received through the first port PORT1 and the third port PORT3, the WIFI RF signal within the 2 GHz band is transmitted and received through a second port PORT2 and the fourth PORT4, and the Bluetooth™ RF signal within the 2 GHz band is processed by the fifth port PORT5. As will be described further, examples provide a way to ensure that these bands are able to operate concurrently without interfering with one another due to isolation problems.

If the at least one connection unit 130 electrically connects the switching unit connected to the second port PORT2 and the switching unit connected to the fifth port PORT5 to each other and electrically connects the switching unit connected to the fourth port PORT4 and the switching unit connected to the fifth port PORT5 to each other, a difference in frequencies of the RF signals processed by the switching units electrically connected to each other by the at least one connection unit 130 is potentially smaller than the preset value. As a result, it becomes quite easy for the Bluetooth™ transmission RF signals to be coupled to each other, such that the switching unit processing the WIFI RF signal does not operate properly and does not fully satisfy the required isolation characteristics.

In the multi-band communications module 100 according to the example, if the at least one connection unit 130 electrically connects the switching unit connected to the first port PORT1 and the switching unit connected to the fifth port PORT5 to each other and electrically connects the switching unit connected to the third port PORT3 and the switching unit connected to the fifth port PORT5 to each other, a difference in frequencies of the RF signals processed by the switching units electrically connected to each other by the at least one connection unit 130 is then larger than the preset value.

Thus, in this example, the switching unit connected to the first port PORT1 and the switching unit connected to the third port PORT3 match the RF signal processing of the 5 GHz band, thereby attenuating the RF signal within the 2 GHz band. Therefore, the Bluetooth™ transmission RF signal within the band is attenuated by the switching unit matching the RF signal processing of the 5 GHz band. As a result, the switching unit processing the WIFI RF signal is protected, and its isolation characteristics are improved.

In further detail, in an example, the switching unit processing the WIFI RF signal within the 2 GHz band has an isolation of about 54 dB, found by (10 dBm-(−44 dBm)), in relation to the switching unit processing the Bluetooth™ RF signal and the switching unit processing the WIFI RF signal within the 5 GHz band has an isolation of about 79 dB, found by (10 dBm-(−69 dBm)), in relation to the switching unit processing the Bluetooth™ RF signal.

Meanwhile, amplitude of RF signals that are required for the angle of arrival (AOA) operation and are received by at least one of the plurality of switching units 120 is reduced. However, in examples, a phase of an RF signal acts as a significant factor in the angle of arrival (AOA) operation, and therefore strength of the RF signal is relatively less important.

For instance, the multi-band communications module 100 according to the example greatly improves isolation characteristics without substantially reducing the angle of arrival (AOA) operation functionality. Therefore, the multi-band communications module 100 is efficiently designed in terms of performance and costs.

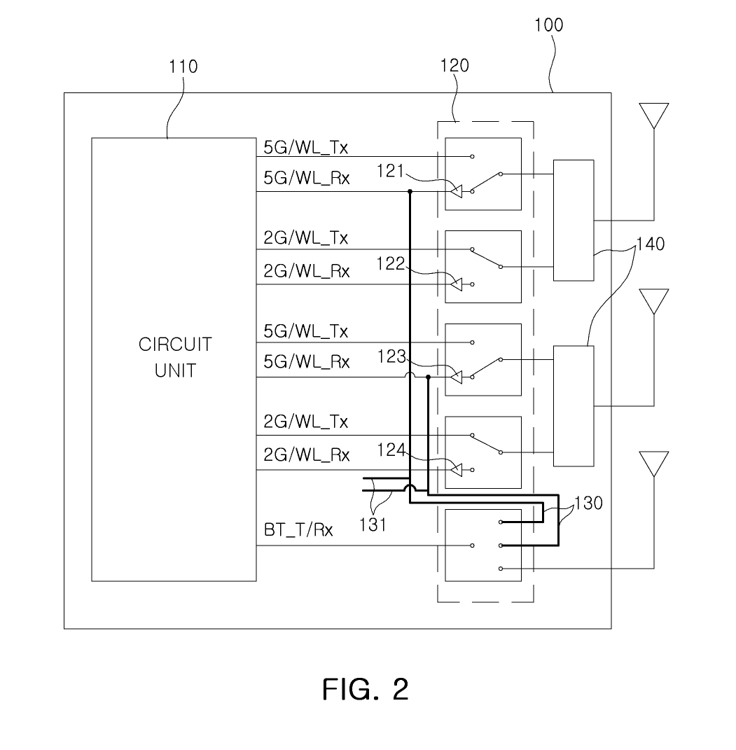

FIG. 2 is a diagram illustrating the multi-band communications module according to the examples in further detail.

Referring to the example of FIG. 2, the plurality of switching units 120 may include a low noise amplifier (LNA) 121 that amplifies the RF signal received from the antenna.

If an amplitude of an RF signal coupled to the low noise amplifier 121 is too large, the low noise amplifier 121 is possibly damaged. However, in the multi-band communications module according to the examples, the low noise amplifier 121 is protected from this potential source of damage.

Referring to the example of FIG. 2, the at least one connection unit 130 includes a matching unit 131 that matches at least two of the plurality of switching units 120 on the basis of their being associated with the 2 GHz band or the 5 GHz band. Therefore, the coupled RF signal is additionally attenuated. For example, the matching unit 130 is implemented using an open stub matching structure.

Referring to the example of FIG. 2, the multi-band communications module further includes a diplexer 140 connected to the plurality of switching units 120, configured to pass one of the RF signals of the plurality of bands and block the remaining RF signals. A diplexer is a passive device that implements frequency-domain multiplexing.

Hereinafter, a high frequency switch 200 according to an example is described further. The same contents as or other contents corresponding to the description of the multi-band communications module 100 described above with reference to FIGS. 1 and 2 is not repeated, for brevity.

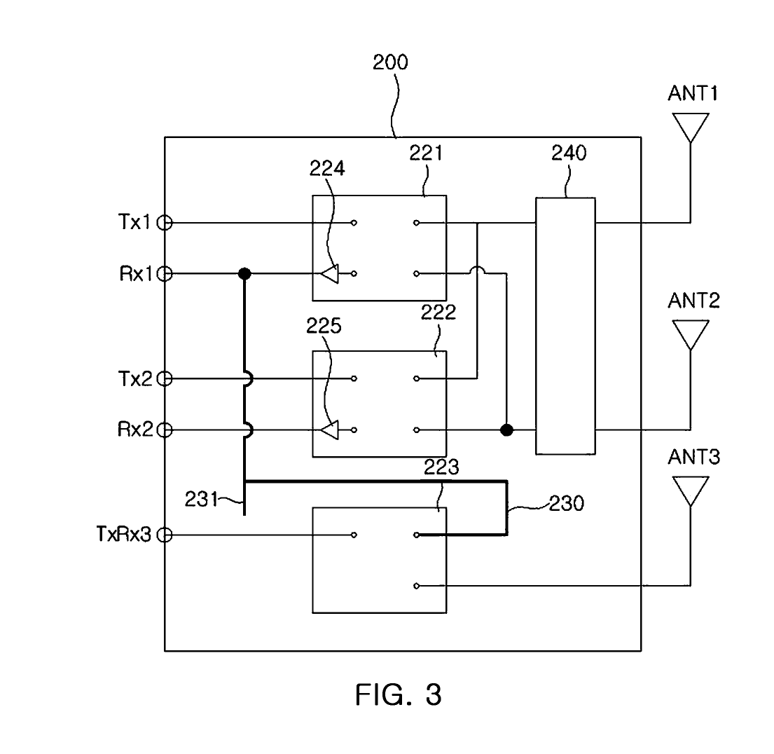

FIG. 3 is a diagram illustrating the high frequency switch according to an example.

Referring to the example of FIG. 3, the high frequency switch 200 includes a first switching unit 221, a second switching unit 222, a third switching unit 223, a connection unit 230, and a diplexer 240.

The first switching unit 221 is connected between a first transmitting port T×1 for transmitting a first RF signal within a first band and a first receiving port R×1 for receiving the first RF signal and a first antenna port ANT1 and a second antenna port ANT2 to transfer or block the first RF signal. For example, the first switching unit 221 includes a first low noise amplifier 224 that amplifies the first RF signal received from the first antenna port ANT1 or the second antenna port ANT2 and outputs the amplified first RF signal to the first receiving port R×1.

The second switching unit 222 is connected between a second transmitting port T×2 for transmitting a second RF signal within a second band and a second receiving port R×2 for receiving the second RF signal and the first antenna port ANT1 and the second antenna port ANT2, in order to transfer or block the second RF signal. For example, the second switching unit 222 further includes a second low noise amplifier 225 that amplifies the second RF signal received from the first antenna port ANT1 or the second antenna port ANT2 and outputs the amplified second RF signal to the second receiving port R×2.

The third switching unit 223 is connected between a third transmitting and receiving port T×R×3 for transmitting and receiving a third RF signal within a first band and a third antenna port ANT3 to transfer or block the third RF signal. For example, the third switching unit 223 receives an RF signal in the angle of arrival operation from the second switching unit 222 and the third antenna port ANT3 and passes the RF signal.

Furthermore, in this example, the connection unit 230 electrically connects a node between the third switching unit 223 and the third antenna port ANT3 and a node between the second switching unit 222 and the second receiving port R×2 to each other. For example, the connection unit 230 electrically connects an output terminal of the second amplifier 225 and the third switching unit 223 to each other. For example, the connection unit 230 includes a matching unit 231 matching the second switching unit 222 and the third switching unit 223 on the basis of being within a third RF signal band.

In the high frequency switch 200 according to an example, the frequency of the first band and the frequency of the second band are different from each other. For example, the first band is a 2 GHz band and the second band is a 5 GHz band.

Therefore, the high frequency switch 200 improves the isolation characteristics to more easily satisfy communications standards and additionally protect internal circuits and devices.

Meanwhile, the diplexer 240 is connected between the first switching unit 221 and the second switching unit 222 and the first antenna port ANT1 and the second antenna port ANT2 so as to transfer one of the RF signals of the plurality of bands and block the remainder thereof.

As set forth above, according to the examples, the multi-band communications module improves isolation characteristics to more easily satisfy the requirements of various communications standards and additionally protect the internal circuits and devices. As a result, operational integrity is preserved.

Furthermore, according to the examples, the multi-band communications module is more efficiently designed in terms of performance and costs by greatly improving the isolation characteristics without substantially reducing the operability and functionality of the multi-band communications module.

The apparatuses, units, modules, devices, and other components illustrated in FIGS. 1-3 that perform the operations described herein with respect to FIGS. 1-3 are implemented by hardware components. Examples of hardware components include controllers, sensors, generators, drivers, memories, comparators, arithmetic logic units, adders, subtractors, multipliers, dividers, integrators, and any other electronic components known to one of ordinary skill in the art. In one example, the hardware components are implemented by computing hardware, for example, by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 1-3. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-3 that perform the operations described herein with respect to FIGS. 1-3 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A multi-band communications module, comprising:
a circuit configured to process RF signals having different bands;
switches respectively connected between the circuit and at least one of antennas, each switch respectively passing or blocking one of the RF signals; and
a connector electrically connecting two switches transferring or blocking RF signals having different bands, among the switches.

2. The multi-band communications module of claim 1, wherein the circuit performs an angle of arrival operation and receives and processes an RF signal for an angle of arrival operation transferred through the connector.

3. The multi-band communications module of claim 2, wherein at least one of the switches processes RF signals required for the angle of arrival operation using a lump processing approach.

4. The multi-band communications module of claim 1, wherein at least one of the switches considers isolation characteristics during passing or blocking an RF signal.

5. The multi-band communications module of claim 1, wherein the circuit processes an RF signal within a 2 GHz band and an RF signal within a 5 GHz band and
the connector electrically connects a switch that transfers or blocks the RF signal within the 2 GHz band and a switch that transfers or blocks the RF signal within the 5 GHz band.

6. The multi-band communications module of claim 5, wherein the connector comprises a matcher configured to match at least two of the switches on the basis of the switches being within the 2 GHz band or the 5 GHz band.

7. The multi-band communications module of claim 6, wherein the matcher is implemented using an open stub matching structure.

8. The multi-band communications module of claim 1, wherein the switching units comprise a low noise amplifier (LNA) configured to amplify an RF signal received from an antenna, and
the connector is connected to an output terminal of the low noise amplifier.

9. The multi-band communications module of claim 1, further comprising:
a diplexer, connected to the switches, configured to transfer one of RF signals having bands and to block the remaining RF signals.

10. The multi-band communications module of claim 1, wherein in response to a transmission RF signal being output from the circuit, the switches pass the transmission RF signal and cut off a receiving RF signal.

11. The multi-band communications module of claim 1, wherein a difference in frequencies of the RF signals that the switches pass or block is larger than a preset value.

12. The multi-band communications module of claim 11, wherein the preset value is about 3 GHz.

13. A high frequency switch, comprising:
a first switch connected between a first transmitting port for transmitting a first RF signal within a first band and a first receiving port for receiving the first RF signal and a first antenna port and a second antenna port, configured to transfer or block the first RF signal;
a second switch connected between a second transmitting port for transmitting a second RF signal within a second band and a second receiving port for receiving the second RF signal and the first antenna port and the second port, configured to transfer or block the second RF signal; and
a third switch connected between a third transmitting and receiving port for transmitting and receiving a third RF signal within the first band and a third antenna port, configured to transfer or block the third RF signal,
wherein a node between the third switch and the third antenna port is electrically connected to a node between the second switch and the second receiving port.

14. The high frequency switch of claim 13, wherein the third switch receives an RF signal for an angle of arrival operation from the second switch and the third antenna port and transfers the received RF signal through the third transmitting and receiving port.

15. The high frequency switch of claim 13, wherein the first switch further comprises a first low noise amplifier configured to amplify the first RF signal received from the first antenna port or the second antenna port and to output the amplified first RF signal into the first receiving port, and
the second switch further comprises a second low noise amplifier configured to amplify the second RF signal received from the first antenna port or the second antenna port and to output the amplified second RF signal into the second receiving port.

16. The high frequency switch of claim 13, further comprising:
a matcher configured to match the second switch and the third switch in response to being within the first band; and
a diplexer connected between the first switch and the second switch and the first antenna port and the second antenna port, configured to transfer one of RF signals having bands and to block the remainder thereof.
